(19) United States
(12) Patent Application Publication
(10) Pub. No.: US 2018/0061433 A1
(43) Pub. Date: Mar. 1, 2018

(54) SIGNAL PROCESSING DEVICE, SIGNAL PROCESSING METHOD, AND COMPUTER PROGRAM PRODUCT

(71) Applicant: KABUSHIKI KAISHA TOSHIBA, Tokyo (JP)

(72) Inventors: Yusuke KIDA, Kawasaki (JP); Toru TANIGUCHI, Yokohama (JP); Makoto HIROHATA, Kawasaki (JP)

(73) Assignee: KABUSHIKI KAISHA TOSHIBA, Tokyo (JP)

(21) Appl. No.: 15/445,682

(22) Filed: Feb. 28, 2017

(30) Foreign Application Priority Data
Aug. 31, 2016 (JP) 2016-169985

(51) Int. Cl. G10L 21/028; G10L 25/84; G10L 21/02

(52) U.S. Cl. CPC G10L 21/028; G10L 21/0205; G10L 25/84

(57) ABSTRACT

According to an embodiment, a signal processing device includes a calculating unit and a generating unit. The calculating unit calculates, for each of a plurality of separation signals obtained through blind source separation, a degree of belonging indicating a degree that the separation signal belongs to a cluster that is set. The generating unit synthesizes the plurality of separation signals each weighted by a weight that increases as the degree of belonging increases, so as to generate a synthetic signal corresponding to the cluster.

### CROSS-REFERENCE TO RELATED APPLICATIONS

This application is based upon and claims the benefit of priority from Japanese Patent Application No. 2016-169985, filed on Aug. 31, 2016; the entire contents of which are incorporated herein by reference.

### FIELD

Embodiments described herein relate generally to a signal processing device, a signal processing method, end a computer program product.

### BACKGROUND

Blind source separation is a technique in which mixed signals of signals output from a plurality of sound sources are input to I input devices (I is a natural number of 2 or more) and I separation signals separated into signals of the respective sound sources are output. For example, when an audio signal including noise is separated into a clean audio and noise by applying this technology, it is possible to provide a user with a comfortable sound with little noise and increase the accuracy of voice recognition.

In the blind source separation, an order of separation signals to be output is known to be indefinite, and it is difficult to know in advance an order in which, among the I separation signals, a separation signal including a signal of a desired sound source is output. For this reason, a technique for selecting one separation signal including a target signal from the I separation signals ex post facto has been proposed. However, depending on influence of noise, reverberation, or the like, there are cases in which the accuracy of the blind source separation is not sufficiently obtained, and a signal output from one sound source is distributed into a plurality of separation signals and then output. In this case, if one separation signal is selected from the I separation signals ex post facto, a low quality sound in which a part of signal components is lost is supplied. As a result, the user is likely to be provided with an uncomfortable sound or an inaccurate voice recognition result.

### BRIEF DESCRIPTION OF THE DRAWINGS

FIG. 1 is a block diagram illustrating an exemplary functional configuration of a signal processing device according to a first embodiment;

FIG. 2 is a flowchart illustrating an example of a processing procedure performed by the signal processing device according to the first embodiment;

FIG. 3 is a diagram illustrating an example of a mixed signal;

FIG. 4 is a diagram illustrating an example of a separation signal;

FIG. 5 is a diagram illustrating an example of a degree of belonging;

FIG. 6 is a diagram illustrating an example of a weight;

FIG. 7 is a diagram illustrating an example of a synthetic signal;

FIG. 8 is a block diagram illustrating an exemplary functional configuration of a signal processing device according to a second embodiment;

FIG. 9 is a flowchart illustrating an example of a processing procedure performed by the signal processing device according to the second embodiment.

FIG. 10 is a schematic diagram illustrating an example of clustering result;

FIG. 11 is a diagram illustrating an example of a synthetic signal;

FIG. 12 is a diagram illustrating an application example of a signal processing device; and

FIG. 13 is a block diagram illustrating an exemplary hardware configuration of a signal processing device.

### DETAILED DESCRIPTION

According to an embodiment, a signal processing device includes a calculating unit and a generating unit. The calculating unit calculates, for each of a plurality of separation signals obtained through blind source separation; a degree of belonging indicating a degree that the separation signal belongs to a cluster that is set. The generating unit synthesizes the plurality of separation signals each weighted by a weight that increases as the degree of belonging increases, so as to generate a synthetic signal corresponding to the cluster.

Embodiments will be described in detail below with reference to the accompanying drawings.

### First Embodiment

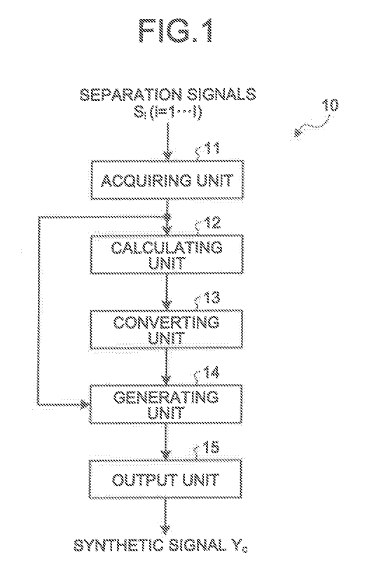

First, a configuration of a signal processing device according to a first embodiment will be described with reference to FIG. 1, FIG. 1 is a block diagram illustrating an exemplary functional configuration of a signal processing device 10 according to the first embodiment. The signal processing device 10 includes an acquiring unit 11, a calculating unit 12, a converting unit 13, a generating unit 14, and an output unit 15 as illustrated in FIG. 1.

The acquiring unit 11 acquires a plurality of separation signals Sᵢ (i=1 to I) (of 1 channels) obtained through the blind source separation. The blind source separation is a process of separating, for example, mixed signals X_{i (i=}1 to I) of signals, which are output from a plurality of sound sources and input to a plurality of microphones constituting a microphone array, into a plurality of separation signals Sᵢ (i=1 to I) which differ according to each sound source. As a method of the blind source separation, methods such as independent component, analysis, independent vector analysis; time frequency masking and the like are known. Any method of the blind source separation, can be used to obtain a plurality of separation signals Sᵢ acquired, through the acquiring unit 11. Each of a plurality of separation signals Sᵢ may be a signal of a frame unit. For example, the acquiring unit 11 may acquire the separation signals Sᵢ of frame units obtained by performing the blind, source separation on she mixed signals Xᵢ in units of frames, or the separation signals Sᵢ acquired by the acquiring unit 11 may be clipped in units of frames, and then a subsequent process may be performed thereon.

It is ideal that a plurality of separation signals Sᵢ obtained through the blind source separation be signals precisely separated for each sound source, but it is difficult to precisely perform the separation for each sound source, and signal components output from one sound source may be distributed into separate channels. Particularly, when the blind source separation is performed online, since it takes time until the mixed signals Xᵢ can be precisely separated into the separation, signals Sᵢ of the respective sound sources, a phenomenon that signal components from one sound, source are distributed into separate channels is remarkable particularly at the initial stage at which the sound source outputs a sound. For example, in the case of human voice, components of voice are often distributed into separate channels until a certain period of time elapses from the start of utterance. The signal processing device 10 of the present embodiment generates a synthetic signal Y_{c} of a high quality sound from the separation signals Sᵢ having even such insufficient separation accuracy as described above.

The calculating unit 12 calculates, for each of a plurality of separation signal Sᵢ acquired by the acquiring unit 11, a degree of belonging K_{ic} indicating a degree that the separation signal Sᵢ belongs to a certain cluster c. In the present embodiment, the cluster c of a category “human voice” is assumed to be determined in advance. In this case, the degree of belonging K_{ic} of each separation signal Sᵢ to the cluster c is calculated, for example, based on a value of a feature quantity indicating the likelihood of human voice obtained from each separation signal Sᵢ. For example, spectral entropy indicating whiteness of an amplitude spectrum or the like can be used as the feature quantity indicating the likelihood of human voice.

In addition to “human voice”, other clusters c according to a type of signal such as, for example, “piano sound,” “water flow sound,” and “cat sound” may be set. When a plurality of clusters c (c=1 to C) are set, the calculating unit 12 calculates, for each cluster c for each of a plurality of separation signals Sᵢ, the degree of belonging K_{ic} acquired by the acquiring unit 11. In this case, the degree of belonging K_{ic} to each cluster c can be calculated based on a value of an arbitrary feature quantity corresponding to each cluster c.

The converting unit 13 converts the degree of belonging K_{ic} to a weight W_{ic} such that the weight increases as the degree of belonging K_{ic} calculated by calculating unit 12 increases. For example, a method using a softmax function indicated in Formula (1) below may be used as the conversion method.

$${W}_{ic} = \frac{exp ( {K}_{ic} )}{{\sum }_{i = 1}^{t} exp ( {K}_{ic} )} \qquad ( 1 )$$

The generating unit 14 synthesizes a plurality of separation signals W_{ic}Sᵢ each weighted by the weight W_{ic} into which the degree of belonging K_{ic} is converted by the converting unit 13, and generates the synthetic signal Y_{c} (Y_{c}=ΣW_{ic}Sᵢ) corresponding to the cluster c.

The output unit 15 outputs the synthetic signal Y_{c} generated by the generating unit 14. The output of the synthetic signal Y_{c} from the output unit 15 may be, for example, reproduction of the synthetic signal Y_{c} using a speaker or may be supply of the synthetic signal Y_{c} to a voice recognition system. Further, the output of the synthetic signal Y_{c} from the cutout unit 15 may be a process of storing the synthetic signal Y_{c} in a file storage device such as an HDD or transmitting the synthetic signal Y_{c} to a network via a communication I/F.

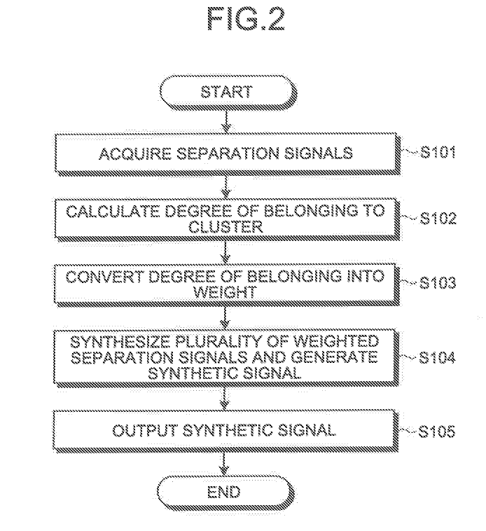

Next, an operation of the signal processing device 10 according to the first embodiment will be described with reference to FIG. 2. FIG. 2 is a flowchart illustrating an example of a processing procedure performed by the signal processing device 10 of the first embodiment. A series of processes illustrated in the flowchart of FIG. 2 is repeatedly performed by the signal processing device 10 at intervals of predetermined units such as frame units.

When the process illustrated in the flowchart of FIG. 2 starts, first, the acquiring unit 11 acquires a plurality of separation signals Sᵢ obtained through the blind source separation (step S101). The plurality of separation signals Sᵢ acquired by the acquiring unit 11 are transferred to the calculating unit 12 and the generating unit 14.

Then, the calculating unit 12 calculates, for each of the plurality of separation signals Sᵢ acquired in step S101, the degree of belonging K_{ic} to the set cluster c (for example, “human voice”) (step S102). The degree of belonging K_{ic} of each of the plurality of separation signals Sᵢ calculated by the calculating unit 12 is transferred to the converting unit 13.

Then, the converting unit 13 converts the degree of belonging K_{ic} calculated for each of the plurality of separation signals Sᵢ in step S102 into the weight: W_{ic} (step S103). The weight W_{ic} of each separation signal Sᵢ into which the degree of belonging K_{ic} converted by the converting unit 13 is transferred to the generating unit 14.

Then, the generating unit 14 performs weighting by multiplying each of the plurality of separation signals Sᵢ acquired in step S101 by the weight W_{ic} into which the degree of belonging K_{ic} is converted in seep S103, and synthesizes a plurality of weighted separation signals W_{ic}Sᵢ, so as to generate the synthetic signal Y_{c} corresponding to the cluster c (step S104). The synthetic signal Y_{c} generated by the generating unit 14 is transferred to the output unit 15.

Finally, the output unit 15 outputs the synthetic signal Y_{c} generated in step S104 (step S105), and then ends a series of processes.

Next, an example of the process according to the present embodiment will be described in further detail using a specific example.

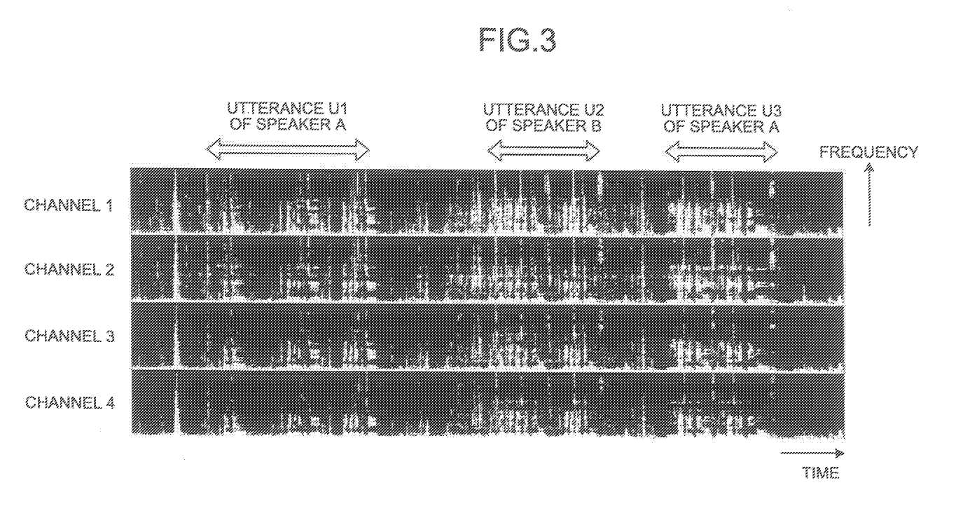

FIG. 3 is a diagram illustrating an example of the mixed signals Xᵢ, and illustrates frequency spectrums of the mixed signals Xᵢ (i=1 to 4) when utterances of two speakers (a speaker A and a speaker B) are collected under an office environment using a microphone array including four microphones of channels 1 to 4. In FIG. 3, a horizontal axis indicates a time, and a vertical axis indicates a frequency. The mixed signals Xᵢ illustrated in FIG. 3 include three utterances arranged in an order of utterance U1 of the speaker A, utterance U2 of the speaker B, and utterance U3 of the speaker A and noises in the office.

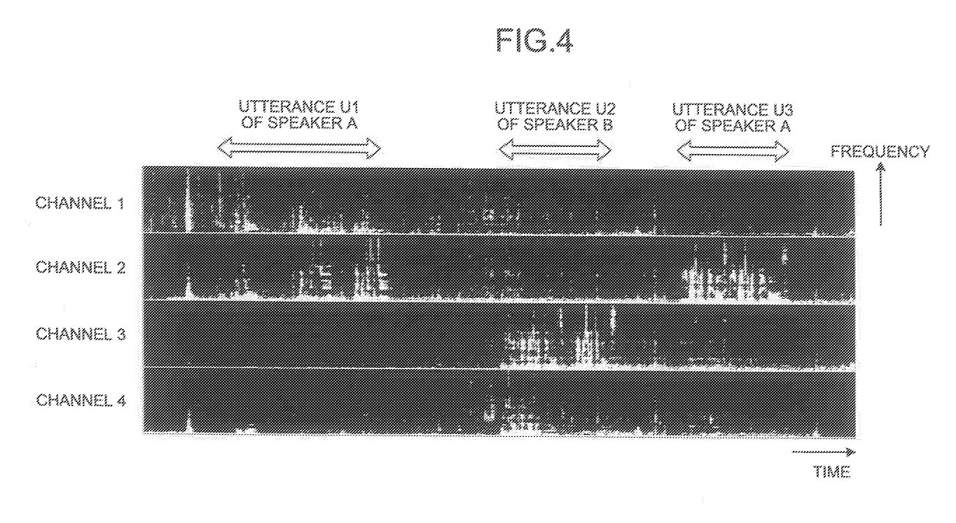

FIG. 4 is a diagram illustrating an example of the separation signals Sᵢ, and illustrates frequency spectrograms of the separation signals Sᵢ (i=1 to 4) obtained as a result of performing the blind source separation on the mixed signals Xᵢ of FIG. 3. In FIG. 4, a horizontal axis indicates a time, and a vertical axis indicates a frequency. The separation signals Sᵢ illustrated in FIG. 4 are obtained by performing online independent vector analysis described in the following Reference Document 1 on the mixed signals Xᵢ of FIG. 3.

Reference Document 1: Toru Tanignchi, et al., “An Auxiliary-Function Approach to Online Independent Vector Analysis for Real-Time Blind. Source Separation,” Proc.HSOMA, May, 2014.

In the case of the utterance U1 of FIG. 4, it can be understood that sound components are distributed into the channel 1 and the channel 2. Similarly, in the case of the utterance U2, sound components are distributed into the channel 3 and the channel 4. Thus, it is difficult to precisely separate the utterance U1 and the utterance U2 through the blind source separation. One of causes lies in that in the case of the online blind source separation performed in this example since a separation matrix for separating the mixed signals X₁ is sequentially updated, it takes time until it is possible to precisely separate a signal after the signal is output from a certain sound source. In this case, when the user listens to the utterance U1 when the separation signal Sᵢ of the channel 1 is reproduced, since some sound components are lost, the user is likely to be provided with an uncomfortable sound. Alternatively, when the separation signals Sᵢ are input to the voice recognition system, an incorrect voice recognition result is likely to be provided the user.

In this example, the synthetic signal Y_{c} of the high quality sound is generated and output based on she separation signals Sᵢ, having even such insufficient separation accuracy as described above. A specific example of the process of steps S102 to S104 in FIG. 2 will be described below under the assumption that the separation signals Sᵢ illustrated, in FIG. 4 are acquired in units of frames in step S101 in FIG. 2.

In step S102, the calculating unit 12 calculates, for each of the separation signals Sᵢ(t) acquired in step S101, the degree of belonging K_{ic}(t) indicating the degree that the separation signal Sᵢ (t) belongs to the set cluster c. Here, t indicates a frame number. In this example, the degree of belonging K_{ic}(t) to the cluster c of the category such as “human voice” is calculated based on the value of the feature quantity indicating the likelihood of voice obtained baaed on spectral entropy.

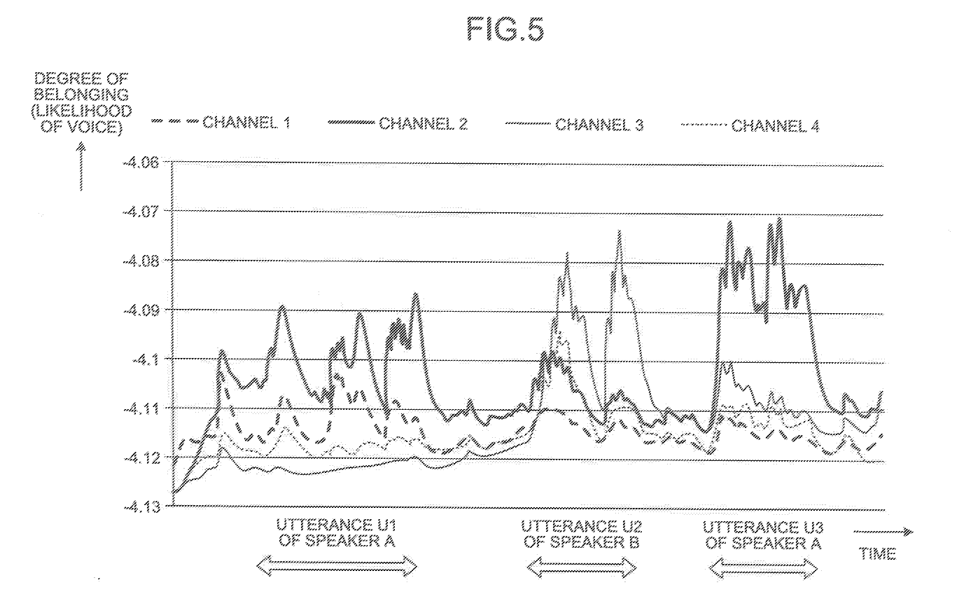

FIG. 5 is a diagram illustrating an example of the degree of belonging K_{ic}, and illustrates the degree of belonging K_{ic} obtained from each of the separation signals Sᵢ in FIG. 4. In FIG. 5, a horizontal axis indicates a time, and a vertical indicates the degree of belonging K_{ic} (the likelihood of voice in this example. In FIG. 5, referring to the degree of belonging K_{ic} at a time when there is utterance, it is understood that a nigh degree of belonging K_{ic} is obtained in channels in which there are voice components of the separation signals Sᵢ. For example, in the utterance U1 in which the voice components are distributed into the channel 1 and the channel 2, the degree of belonging K_{ic} of the channels 1 and 2 is higher than in the other channels.

Then, in step S103, the converting unit 13 converts the degree of belonging K_{ic}(t) calculated in step S102 to the weight W_{ic}(t) such that the weight W_{ic} increases as the degree of belonging K_{ic} increases.

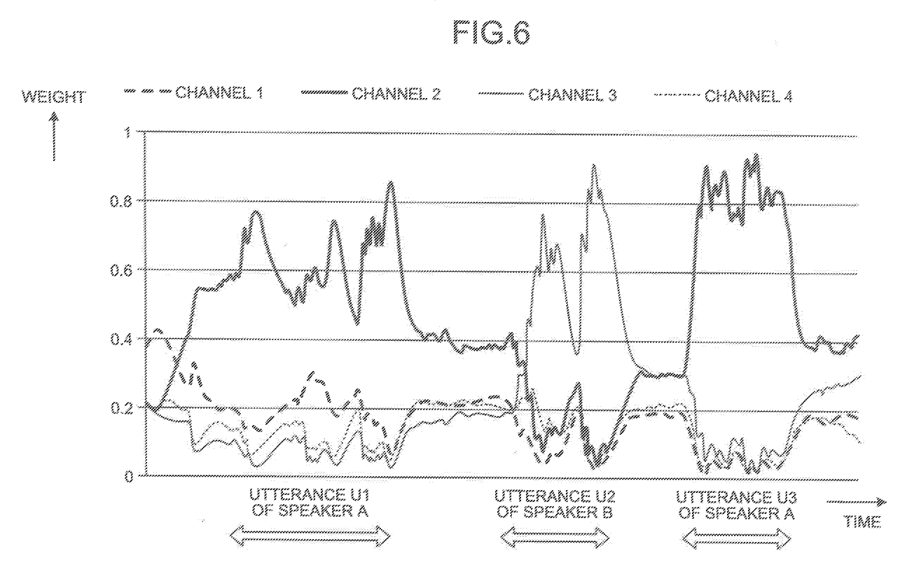

FIG. 6 is a diagram illustrating an example of the weight W_{ic} and illustrates the weight W_{ic} obtained from the degree of belonging K_{ic} in FIG. 5. In FIG. 5, a horizontal axis indicates a time, and a vertical axis indicates a weight. In this example, the degree of belonging K_{ic} is converted to the weight W_{ic} by multiplying a value of spectrum entropy by a constant in order to adjust the weight W_{ic} then applying the softmax function indicated in Formula (2) below, and performing normalization so that a total sum of the weights W_{ic} of all the channels is 1.0. When FIG. 6 is compared with FIG. 5, it is understood that that the channels in which the degree of belonging K_{ic} is high becomes high in the weight W_{ic} through the conversion method described in this example.

$${W}_{ic} ( t ) = \frac{exp ( {K}_{ic} ( t ) )}{{\sum }_{i = 1}^{t} exp ( {K}_{ic} ( t ) )} \qquad ( 2 )$$

Then, in step S104, the generating unit 14 multiplies each of the separation signals Sᵢ (t) acquired in step S101 by the weight W_{ic} (t) obtained in step S103, and synthesizes a plurality of weighted separation signals W_{ic}Sᵢ (t), so as to generate the synthetic signal Y_{c}(t). In this example, the synthetic signal Y_{c}(t) is generated by Formula (3) below.

Y_{c}(t)=Σᵢ₌₁¹W_{ic}(t)·Sᵢ(t) (3)

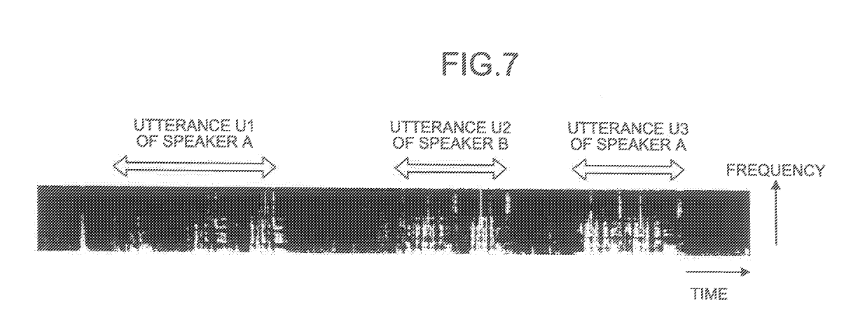

FIG. 7 is a diagram illustrating an example of the synthetic signal Y_{c}, and illustrates a frequency spectrogram of the synthetic signal Y_{c} generated by multiplying each of the separation signals Sᵢ of FIG. 4 by the weight W_{ic} of FIG. 6 and adding the resulting signals. In FIG. 7, a horizontal axis indicates a time, and a vertical axis indicates a frequency. It is understood that by performing the process according to the present embodiment on the separation signals Sᵢ illustrated in FIG. 4, the synthetic signal Y_{c} including all the three utterances, that is, the utterance U1 in which the voice components in the separation signal Sᵢ illustrated in FIG. 4 are distributed into the channel 1 and the channel 2, the utterance U2 in which the voice components are distributed into the channel 3 and the channel 4, and the utterance U2 included in the channel 2, as illustrated in FIG. 7.

As described above, it is understood that, for example, the degree of belonging K_{ic} to the cluster c of the category such as “human voice” is calculated for each of a plurality of separation signals Sᵢ having the insufficient separation accuracy, the degree of belonging K_{ic} is converted to the weight W_{ic}, the plurality of separation signals Sᵢ are weighted by the obtained weights W_{ic} and the plurality of weighted separation signals W_{ic}Sᵢ are synthesized, whereby the synthetic signal Y_{c} of the high quality voice is obtained. Then, the synthetic signal Y_{c} is output, and thus, for example, it is possible to provide the user with the comfortable voice or an accurate voice recognition result.

As described above in detail using the specific example, the signal processing device 10 of the present embodiment calculates, for each of a plurality of separation signals Sᵢ obtained through the blind source separation, the degree of belonging K_{ic} indicating the degree that the separation signal Sᵢ belongs to the set cluster c. Then, the degree of belonging K_{ic} is converted into the weight W_{ic} such that the weight increases as the degree of belonging K_{ic} increases. Then, a plurality of separation signals W_{ic}Sᵢ weighted by the weights W_{ic} are synthesized to thereby generate the synthetic signal Y_{c} and output the synthetic signal Y_{c}. Therefore, according to the signal processing device 10 of the present embodiment, it is possible to provide the high-quality sound even when the accuracy of the blind source separation is not sufficient.

### Second Embodiment

Next, a second embodiment will be described. In the second embodiment, a plurality of clusters c (c=1 to 0) are generated based on similarity among a plurality of separation signals Sᵢ, and the degree of belonging K_{ic} (c=1 to C) to each cluster c is calculated for each of the plurality of separation signals Sᵢ based on proximity of the separation signal Sᵢ to each cluster c. Then, a plurality of separation signals W_{ic}Sᵢ each weighted by the weight into which the degree of belonging K_{ic} corresponding to the cluster c is converted are synthesized for each of the plurality of clusters c, and synthetic signals Y_{c} of the plurality of clusters c (c=1 to C) are generated Thereafter, from among the generated synthetic signals Y_{c} of the clusters c, the synthetic signal(s) Y_{c} including human voice is selected and output.

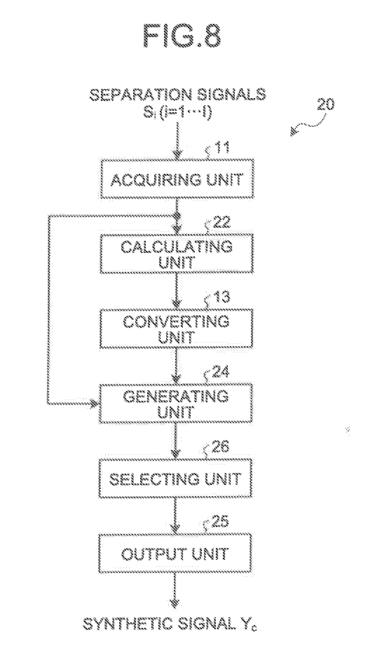

First, a configuration of a signal processing device according to the second embodiment will be described with reference to FIG. 8. FIG. 8 is a block diagram illustrating an exemplary functional configuration of a signal processing device 20 according to the second embodiment. The signal processing device 20 includes an acquiring unit 11, a calculating unit 22, a converting unit 13, a generating unit 24, a selecting unit 26, an a axial output unit 25 as illustrated in FIG. 8.

The acquiring unit 11 acquires a plurality of separation signals Sᵢ obtained through the blind source separation, similarly to the first embodiment.

The calculating unit 22 calculates, for each of the plurality of separation signals Sᵢ acquired through the acquiring unit 11, a degree of belonging K_{ic} (c=1 to C) to each of a plurality of clusters c (c=1 to C). The calculating unit 22 generates (sets) a plurality of clusters c, for example, based on similarity among the plurality of separation signals Sᵢ acquired by the acquiring unit 11. Then, the degree of belonging K_{ic} of each separation signal Sᵢ, to each cluster c is obtained by a method based on the proximity to the cluster c calculated from the separation signal Sᵢ here, as a reference of the proximity of the separation signal Sᵢ to the cluster c, for example, a distance between the separation signal Sᵢ and a centroid of the cluster c may be used, or the likelihood of the separation signal Sᵢ with respect to a statistical model learned for each cluster c may be used.

The converting unit 13 converts the degree of belonging K_{ic} calculated by the calculating unit 22 to the weight W_{ic}, similarly to the first embodiment,

The generating unit 24 generates the synthetic signal Y_{c} (c=1 to C) of each of a plurality of clusters c set by the calculating unit 22 by a similar technique to that of the first embodiment. In other words, the generating unit 24 generates a plurality of synthetic signals Y_{c} respectively corresponding to the plurality of clusters c.

The selecting unit 26 selects the synthetic signal Y_{c} including human voice from among the plurality of synthetic signals Y_{c} generated by the generating unit 24. As a method of selecting the signal including human voice, for example, a method of comparing the value of the feature quantity indicating the likelihood of human voice obtained from each synthetic signal Y_{c} with a predetermined threshold value and selecting the synthetic signal Y_{c} in which the value of the feature quantity exceeds the threshold value may be used. As the feature quantity indicating the likelihood of human voice, for example, the above-mentioned spectral entropy or the like may be used.

The output unit 25 outputs the synthetic signal Y_{c} selected by the selecting unit 26. Similarly to the first embodiment, the output of the synthetic signal Y_{c} from the output unit 25 may be, for example, reproduction of the synthetic signal Y_{c} using a speaker or may be supply of the synthetic signal Y_{c} to a voice recognition system. Further, the output of the synthetic signal Y_{c} from the output unit 25 may be a process of storing the synthetic signal Y_{c} in a file storage device such as an HDD or transmitting the synthetic signal Y_{c} to a network via a communication I/F.

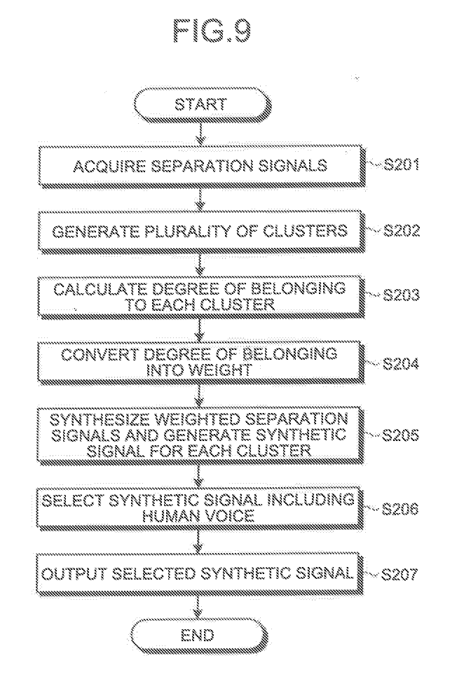

Next, an operation of the signal processing device 20 according to the second embodiment will be described with reference to FIG. 9. FIG. 9 is a flowchart illustrating an example of a processing procedure performed by the signal processing device 20 according to the second embodiment. A series of processes illustrated in the flowchart of FIG. 9 is repeatedly performed by the signal processing device 20 at intervals of predetermined units such as frame units.

When the process illustrated in the flowchart of FIG. 9 starts, first, the acquiring unit 11 acquires a plurality of separation signals Sᵢ obtained through the blind source separation (step S201). The plurality of separation signals Sᵢ acquired by the acquiring unit 11 are transferred to the calculating unit 22 and the generating unit

Then, the calculating unit 22 generates (sets) a plurality of clusters c based on similarity among the plurality of separation signals Sᵢ acquired in step S201 (step S202). The plurality of clusters c generated here are set as a target cluster c for a calculation of the degree of belonging K_{ic}.

Then, the calculating unit 22 calculates, for each of the plurality of separation signals Sᵢ acquired in step S201, the degree of belonging K_{ic} to each of the plurality of clusters c set in step S202 (step S203). The degree of belonging K_{ic} to each cluster c for each of the separation signals Sᵢ calculated by the calculating unit 22 is transferred, to the converting unit 13.

Next, the converting unit 13 converts the degree of belonging to each cluster c calculated for each of the plurality of separation signals Sᵢ in step S203 into the weight W_{ic} (step S204). The weight into which the degree of belonging K_{ic} is covered by the converting unit 13 is transferred to the generating unit 24.

Then, the generating unit 24 performs weighting for each of the plurality of clusters c set in step S202 by multiplying each of the plurality of separation signals; 3: acquired in step S201 by the weight W_{ic}, into which the degree of belonging K_{ic} is converted in step S204, and synthesizes a plurality of weighted separation signals W_{ic}Sᵢ so as to generate the synthetic signals Y_{c} respectively corresponding to the plurality of clusters c (step S205). The plurality of synthetic signals Y_{c} of the clusters c generated by the generating unit 24 are transferred to the selecting unit 26.

Then, the selecting unit 26 selects the synthetic signal Y_{c} including human voice from among the plurality of synthetic signals Y_{c} generated for the clusters c in step S205 (step S206). The synthetic signal Y_{c} selected by the selecting unit 26 is transferred to the output unit 25.

Finally, the output unit 25 outputs the synthetic signal Y_{c} selected in step S206 (step S207), and a series of processes ends.

Next, an example of the process according to the present embodiment will be described in further detail using a specific example. A specific example of the process of steps S202 to S206 in FIG. 9 will be described below under the assumption that the separation signals Sᵢ illustrated in FIG. 4 are acquired and divided in units of frames in step S201 in FIG. 9.

In step S202, the calculating unit 22 generates a plurality of clusters c based on the similarity among the plurality of separation signals Sᵢ illustrated in FIG. 4. In this example, first, each of the plurality of separation signals Sᵢ acquired in step S201 is divided into frames, and then an acoustic feature quantity such as a Mel-Frequency Cepstral Coefficient (MFCC) is calculated for each frame. Thereafter, a clustering technique such as a mean shift technique is performed in a batch manner using the acoustic feature quantities calculated from all the frames as samples. The number of samples used for clustering is, for example, 4 000 (1000×4) when the number of frames is 1000, and the number of channels is 4.

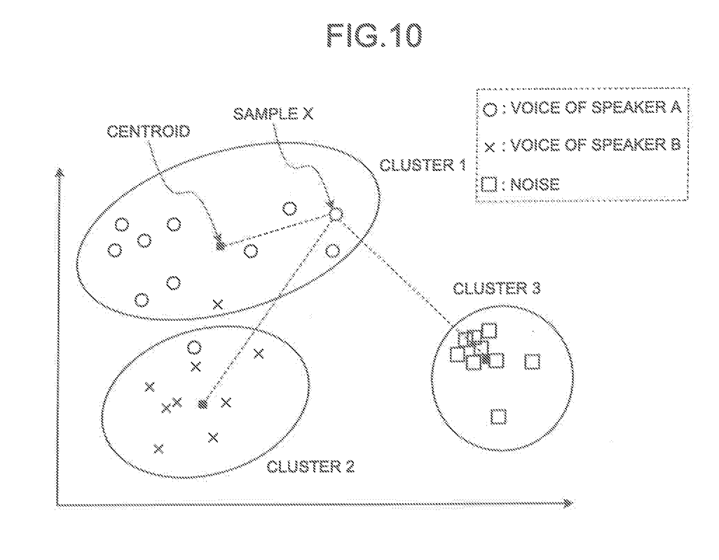

FIG. 10 is a schematic diagram illustrating an example of a clustering result. A dimension number of the acoustic feature quantity used in clustering is usually larger than 3, but, for the sake of description, a clustering result is here illustrated in two dimensions. In this example, it is understood that as a result of clustering described above, three clusters, that is, clusters 1 to 3 are generated as illustrated in FIG. 10, and the cluster 1 is configured with voice of a speaker A, the cluster 2 is configured with voice of a speaker B, and cluster 3 is configured with noise. In this example, the three clusters are set as the target clusters c for a calculation of the degree of belonging K_{ic}.

Next, in step S203, the calculating unit 22 calculates, for each of the plurality of separation signals Sᵢ(t) of the frame unit, the degree of belonging K_{ic}(t) to each of the three clusters c generated in step S202. Here, t indicates a frame number. In this example, the degree of belonging K_{ic}(t) is calculated, for example, as indicated in Formula (4) below.

K_{c}(t)=−∥fᵢ(t)−e_{c}∥ (4)

Here, fᵢ(t) in Formula (4) indicates a vector of an acoustic feature quantity calculated from a t-th frame in the separation signal Sᵢ, and e_{c} indicates the centroid of the cluster c on an acoustic feature space. A double parenthesis indicates a distance. In other words, in Formula (4), a value obtained by multiplying a distance between a frame (sample) and the centroid of the cluster on the acoustic feature space by minus one is calculated as the degree of belonging K_{ic}(t). By calculating the degree of belonging K_{ic}(t) as described above, for example, in the case of a sample X illustrated in FIG. 10, since the closest centroid is the centroid of the cluster 1, the degree of belonging K_{ic}(t) to the cluster 1 of the sample X has a high value. On the other hand, since the centroids of the clusters 2 and 3 are away from the sample X, the degree of belonging K_{ic}(t) of the sample X has a low value.

Then, in step S204, the converting unit 13 converts the degree of belonging K_{ic}(t) calculated in step S203 into the weight W_{ic}(t) using the soft max function indicated in Formula (2) or the like.

Then, in step S200, the generating unit 24 multiplies each of the separation signals Sᵢ(t) of the frame unit by the weight W_{ic}(t) obtained in step 204 for each of the three clusters c generated in step S202, and synthesizes the weighted separation signals W_{ic}Sᵢ(t), so as to generate the synthetic signals Y_{c}(t). In this example, three synthetic signals Y_{c}(t) respectively corresponding to the three clusters c are generated by Formula (3).

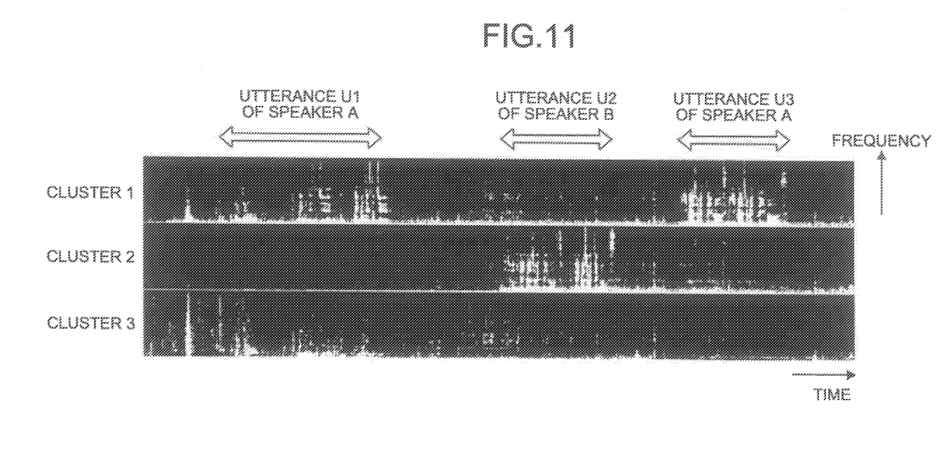

FIG. 11 Is a diagram Illustrating an example of the synthetic signals Y_{c}, and Illustrates frequency spectrograms of the synthetic signals Y_{c} respectively corresponding to the three clusters (the clusters 1 to 3) of FIG. 10. In FIG. 11, a horizontal axis indicates a time, and a vertical axis indicates a frequency. It is understood that a large amount of voice components of the speaker A (voice components of the utterance U1 and the utterance U3) are included in the synthetic signal Y_{c} corresponding to the cluster 1 as illustrated in FIG. 11. This is because there are many voice frames of the speaker A near the centroid of the cluster 1, and thus a large weight for the cluster 1 is applied to these frames. Similarly, it is understood that a large amount of voice components of the speaker B (voice components of the utterance U2) are included in the synthetic signal Y_{c} corresponding to the cluster 2, and a large amount of noise is included in the synthetic signal Y_{c} corresponding to the cluster 3.

Then, in a step S206, the selecting unit 26 selects the synthetic signal Y_{c}(t) including human voice from among the three synthetic signals Y_{c}(t) generated in the step S205. In this example, the synthetic signal Y_{c}(t) corresponding to the cluster 1 and the cluster 2 among the synthetic signals Y_{c}(t) corresponding to the three clusters includes human voice. Therefore, the synthetic signal Y_{c}(t) corresponding to the cluster 1 and the synthetic signal Y_{c}(t) corresponding to the cluster 2 are selected. Then, the selected synthetic signals Y_{c}(t) are output from the output unit 25.

As described above in detail using the specific example, the signal processing device 20 of the present embodiment sets a plurality of clusters c based on the similarity among a plurality of separation signals Sᵢ obtained through the blind source separation, and calculates the degree of belonging K_{ic} to each of the plurality of clusters c for each of the plurality of separation signals Sᵢ. Then, the degree of belonging K_{ic} to each of the plurality of clusters c is converted into the weight W_{ic}, a plurality of separation signals W_{ic}Sᵢ each weighted by the weight W_{ic} are synthesized for each of the plurality of clusters c, and the synthetic signals Y_{c} are generated. Then, among the plurality of synthetic signals Y_{c} generated for the plurality of clusters c, the synthetic signal (s) Y_{c} including human voice is selected and outputted. Therefore, according to the signal processing device 20 of the present embodiment, it is possible to supply the high quality sound even when the accuracy of the blind source separation is not sufficient, similarly to the first embodiment. Furthermore, in the present embodiment, it is possible to separate and provide a signal including a sound in a category with a finer grain sire than human voice, for example, it is possible to separate and provide utterance of each speaker.

Supplemental Description

The signal processing device 10 according to the first embodiment and the signal processing device 20 according to the second embodiment (hereinafter, referred to collectively as a “signal processing device 100 of an embodiment”) can be suitably used as, for example, a noise suppression device that extracts a clean sound from an audio signal with noise. The signal processing device 100 of the embodiment can be implemented by various devices in which a function of the noise suppression device such as a personal computer, a tablet terminal, a mobile phone, or a smartphone.

Further, the signal processing device 100 of the present embodiment may be implemented by a sever computer in which the above-described respective units (the acquiring unit 11, the calculating unit 12 or 22, the converting unit 13, the generating unit 14 or 24, the output unit 15 or 25, the selecting unit 26, and the like) are implemented by predetermined program (software) and may be configured to be used together with, for example, a headset system including a plurality of microphones and a commmication terminal.

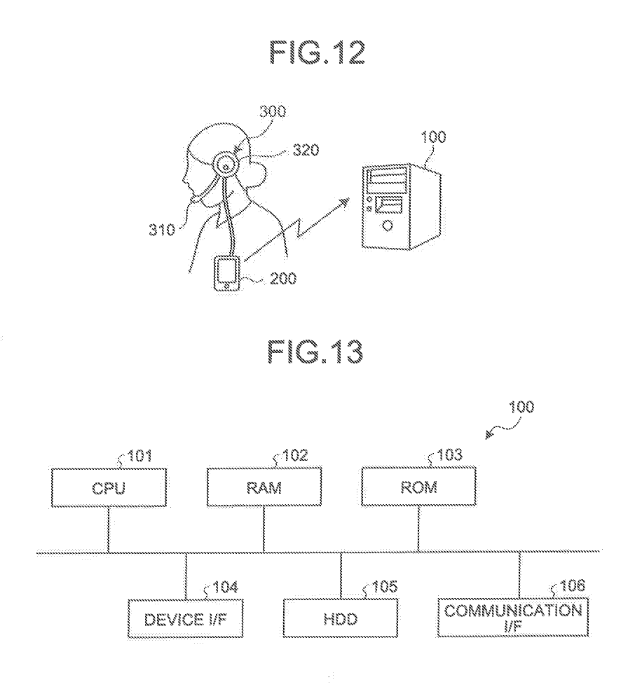

FIG. 12 illustrates an application example of the signal processing device 100 as the server computer. In FIG. 12, a server computer having the function of the signal processing device 100 of the embodiment is denoted by reference numeral 100. Here, a headset system 300 includes a sound collecting unit 310 including a plurality of microphones and a speaker unit 320 worn on an ear of the user. The headset system 300 collects a signal in which utterance of the user is mixed with noise through the sound collecting unit 310, and transmits a signal to a communication terminal 200 connected thereto in a wired or wireless manner.

The communication terminal 200 transmits the signal received from the headset system 300 to the server computer 100 via a communication line. In this case, the server computer 100 performs the blind source separation on the received signal, then generates the synthetic signal from, the separation signals obtained through the blind source separation by the function of the signal processing device 100 of the embodiment, and obtains clean utterance of she user from which noise has been removed.

Alternatively, the communication terminal 200 may be configured to perform the blind source separation and transmit the separation signals to the server computer 100 via the communication line. In this case, the server computer 100 generates the synthetic signal from the separation signals received from the communication terminal 200 by the function of the signal processing device 100 of the embodiment, and obtains clean utterance of the user from, which, noise has been removed.

Further, the server computer 100 may perform a voice recognition process on obtained utterance and obtain a recognition result. Furthermore, the server computer 100 may store the obtained utterance or the recognition result in storage or may transmit the obtained utterance or the recognition result to the communication terminal via the communication line.

The server computer 100 illustrated in FIG. 12 receives the signal collected through the sound collecting unit 310 of the headset system 300 or the separation signals obtained by performing the blind source separation on the signal from the communication terminal 200, but when the headset system 300 has the function of the communication terminal 200, the signal collected by the sound collecting unit 310 or the separation signals obtained by performing the blind source separation on the signal may be received from the headset system 300.

FIG. 13 is a block diagram illustrating an exemplary hardware configuration of the signal processing device 100 of the embodiment. The signal processing device 100 of the embodiment has a hardware configuration of a common computer that includes, for example, a processor such as the GPP 101, storage devices such as a RAM 102 and a ROM 103, a device I/F 104 for a connection with peripheral devices, a file storage device such as a HDD 105, and a communication I/F 106 that performs communication with the outside via a network as illustrated in FIG. 13.

At this time, the program is recorded, in, for example, a magnetic disk (a flexible disk, a hard disk, or the like), an optical disk (a CD-ROM, a CD-R, a CD-RW, a DVD-ROM, a DVD+R, a DVD±RW, a Blu-ray (registered trademark) Disc, or the like), a semiconductor memory, or a recording medium similar thereto and provided. A recording medium having the program recorded therein can have any storage format as long as it is a recording medium which is readable by a computer system. Further, the program may be configured to be installed in a computer system in advance, or the program may be distributed via the network and appropriately installed in a computer system.

The program executed by the computer system has a module configuration including the above-described respective units (the acquiring unit 11, the calculating unit 12 or 22, the converting unit 13, the generating unit 14 or 24, the output unit 15 or 25, and the selecting unit 26) which are functional components of the signal processing device 100 of the embodiment, and when the program is appropriately read and executed through the processor, the above-described respective units are generated on a main memory such as the RAM 102.

Further, the above-described respective units of the signal processing device 100 of the embodiment can be implemented by a program (software), and all or some of the above-described respective units of the signal processing device 100 of the embodiment can be implemented by dedicated hardware such as an Application Specific Integrated Circuit (ASIC) or a Field-Programmable Gate Array (FPGA).

Further, the signal processing device 100 of the embodiment may be configured as a network system to which a plurality of computers are connected to be able to perform communication, and the above-described respective units may be distributed to and implemented by a plurality of computers.

According to at least one of the above-described embodiments, it is possible to obtain a high quality sound close to an original signal of the sound source even when the sound components are dispersed into a plurality of channels due to the blind source separation. As a result, it is possible to provide the user with a comfortable sound. Alternatively, when the separation signals are input to the voice recognition system, an accurate voice recognition result can be provided to the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. A signal processing device, comprising;
a calculating unit configured to calculate, for each of a plurality of separation signals obtained through blind source separation, a degree of belonging indicating a degree that the separation signal belongs to a cluster that is set; and
a generating unit configured to synthesize the plurality of separation signals each weighted by a weight that increases as the degree of belonging increases, so as to generate a synthetic signal corresponding to the cluster.

2. The device according to claim 1, wherein
the cluster is a cluster of a category of human voice, and
the calculating unit calculates, for each of the plurality of separation signals, the degree of belonging based on a value of a feature quantity indicating a likelihood of human voice.

3. The device according to claim 1, wherein
the calculating unit calculates, for each of the plurality of the separation signals, the degree of belonging to each of a plurality of clusters, and
the generating unit generates a plurality of synthetic signals respectively corresponding to the plurality of clusters.

4. The device according to claim 3, wherein
the calculating unit sets the plurality of clusters based on similarity among the plurality of separation signals, and calculates the degree of belonging to each of the plurality of clusters based on proximity of each of the separation signals to the each of the clusters.

5. The device according to claim 3, further comprising a selecting unit configured to select the synthetic signal including the human voice from among the plurality of synthetic signals.

6. The device according to claim 5, wherein
the selecting unit selects, from among the plurality of synthetic signals, the synthetic signal in which a value of a feature quantity indicating a likelihood of human voice exceeds a predetermined threshold value.

7. The device according to claim 1, wherein
the calculating unit performs normalization such that a total sum of weights for weighting the plurality of separation signals is a predetermined value.

8. The device according to claim 1, wherein
each of the plurality of separation signals is a signal of a frame unit, and
the calculation of the degree of belonging by the calculating unit and the generation of the synthetic signal by the generating unit are performed in units of frames.

9. A signal processing method performed by a signal processing device, the method comprising:
calculating, for each of a plurality of separation signals obtained through blind source separation, a degree of belonging indicating a degree that the separation signal belongs to a cluster that is set; and
synthesizing the plurality of separation signals each weighted by a weight that increases as the degree of belonging increases, so as to generate a synthetic signal corresponding to the cluster.

10. A computer program product comprising a computer-readable medium including a computer program causing a computer to implement;
a function of calculating, for each of a plurality of separation signals obtained through blind scarce separation, a degree of belonging indicating a degree that the separation signal belongs to a cluster that is set; and
a function of synthesizing the plurality of separation signals each weighted by a weight chat increases as the degree of belonging increases, so as to generate a synthetic signal corresponding to the cluster.
